(19) United States
(12) Patent Application Publication
(10) Pub. No.: US 2018/0143039 A1
(43) Pub. Date: May 24, 2018

(54) OPTICAL ENCODER

(71) Applicant: HIWIN MIKROSYSTEM CORP., Taichung City (TW)

(72) Inventors: Zheng-Lin HE, Taichung City (TW); Mang OU-YANG, Taichung City (TW); Yin-Yuan CHEN, Taichung City (TW); Yan-Shiang WANG, Taichung City (TW); Chi-Yuan CHENG, Taichung City (TW)

(21) Appl. No.: 15/359,074

(22) Filed: Nov. 22, 2016

(51) Int. Cl. G01D 5/347

(52) U.S. Cl. CPC G01D 5/3473

(57) ABSTRACT

The present invention provides an optical encoder, mainly characterized in that a second light-transmitting region has two individual circular areas, and the circular areas correspond to positions of a same period that sensing light passes through a code disc, so as to obtain an analog signal closer to a sine wave as well as achieve an easy manufacturing process.

### BACKGROUND OF THE INVENTION

### Field of the Invention

The present invention relates to position sensing technologies, and more particularly to an optical encoder.

### Description of the Related Art

An optical encoder is used for measuring a mechanical geometric displacement amount by using a signal obtained from the change of sensing light. To enable the resulting analog signal to be closer to a sine-wave signal, the related art discloses that the shape of a light-receiving area is changed into a shape such as a rectangular shape, a trapezoid shape, a rhombus shape, a wave shape, or a V-shape, so as to obtain an analog signal close to a sine wave.

Although the related art has disclosed that a sensed analog signal may be adjusted to be closer to a sine-wave value by changing the shape of the light-receiving area, the shape is excessively complex and is inconvenient for processing, thus causing a disadvantage of a difficult manufacturing process.

### SUMMARY OF THE INVENTION

Therefore, the main objective of the present invention is to provide an optical encoder whose light-receiving area has a shape formed by at least two circles, so as to obtain an analog signal closer to a sine wave as well as achieve an easy manufacturing process of the shape of the light-receiving area as compared with the related art.

Therefore, to achieve the foregoing objective, the optical encoder provided in the present invention includes a light-emitting unit for emitting sensing light, a light sensing unit for sensing the sensing light, and a code disc for periodically preventing the sensing light from arriving at the light sensing unit. The light sensing unit has a light-receiving element for sensing the sensing light periodically passing through the code disc, and a mask, disposed between the light-receiving element and the code disc, and provided with at least one second light-transmitting region allowing the sensing light to pass. The optical encoder is mainly characterized in that the second light-transmitting region has two individual circular areas, and the circular areas correspond to positions of a same period that the sensing light passes through the code disc.

Further, the second light-transmitting region further includes two triangular areas, disposed between the circular areas and connected to each other at the apex, where two sides of each triangular area are tangential to an adjacent one of the circular areas.

The number of circular areas of the second light-transmitting region is three.

The second light-transmitting region further includes two connection areas, respectively disposed between the circular areas, where the boundaries of the connection areas are formed by tangents of the adjacent circular areas.

The radii of the circular areas are different from each other.

### BRIEF DESCRIPTION OF THE DRAWINGS

FIG. 1 is a three-dimensional top view of an optical encoder according to a first embodiment of the present invention;

FIG. 2 is a three-dimensional bottom view of the optical encoder according to the first embodiment of the present invention;

FIG. 3 is a schematic plan view of the optical encoder according to the first embodiment of the present invention;

FIG. 4 is a schematic plan view of a mask of the optical encoder according to the first embodiment of the present invention;

FIG. 5 is a plan view of a single second light-transmitting region in the optical encoder according to the first embodiment of the present invention;

FIG. 6 is a plan view of a single second light-transmitting region of an optical encoder according to a second embodiment of the present invention;

FIG. 7 is a plan view of a single second light-transmitting region of an optical encoder according to a third embodiment of the present invention;

FIG. 8 is a plan view of a single second light-transmitting region of an optical encoder according to a fourth embodiment of the present invention;

FIG. 9 is a schematic plan view of a mask of an optical encoder according to a fifth embodiment of the present invention;

FIG. 10 is a plan view of a single second light-transmitting region of the optical encoder according to the fifth embodiment of the present invention;

FIG. 11 is a diagram of a signal obtained through MATLAB simulation of the optical encoder according to the fifth embodiment of the present invention; and

FIG. 12 is a diagram of a signal obtained through ASAP simulation of the optical encoder according to the fifth embodiment of the present invention.

### DETAILED DESCRIPTION OF THE PREFERRED EMBODIMENTS

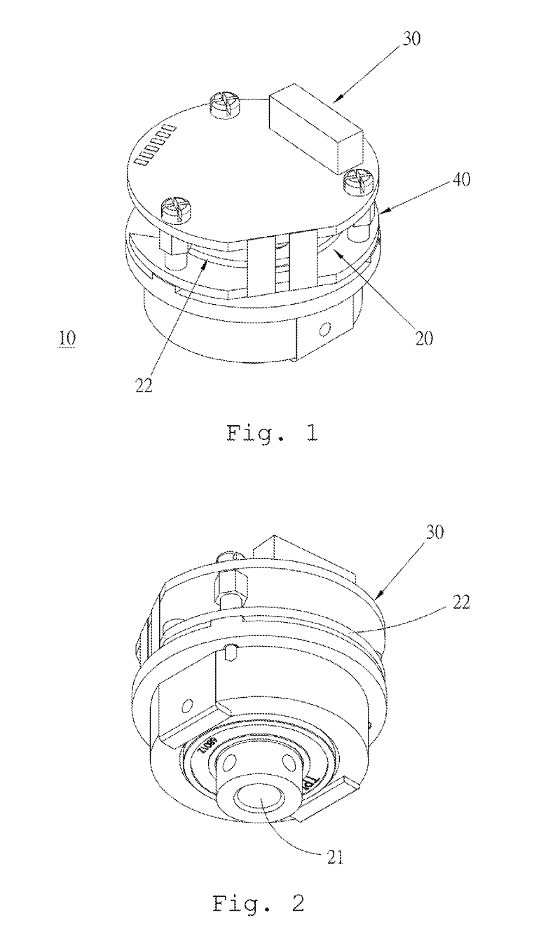

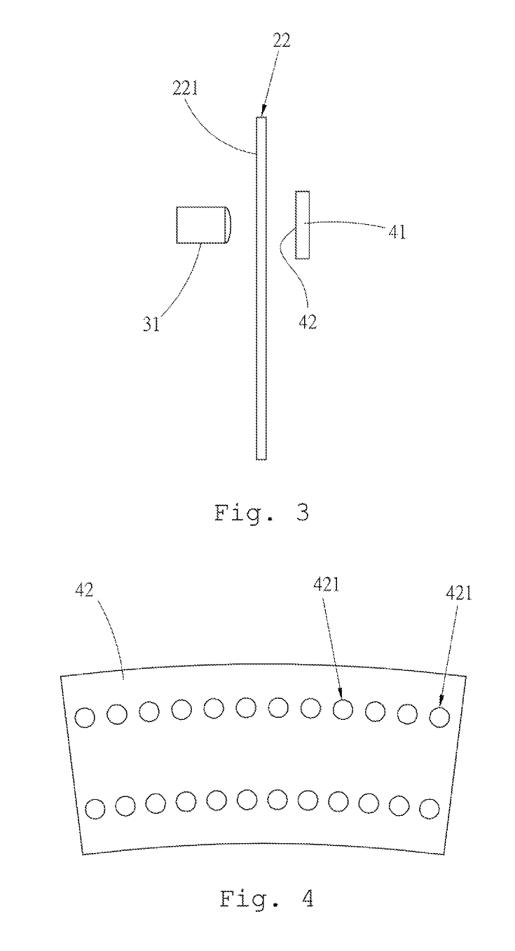

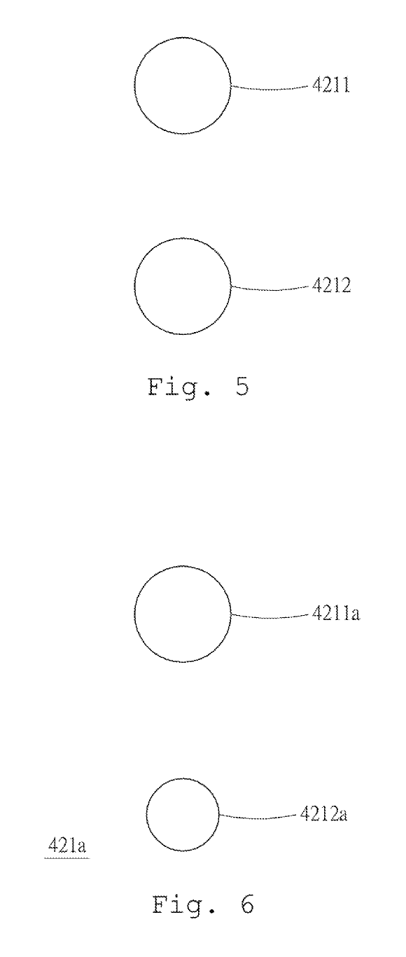

Firstly, referring to FIG. 1 to FIG. 5, an optical encoder (10) provided in a first embodiment of the present invention mainly includes a code disc unit (20), a light-emitting unit (30), and a light sensing unit (40).

The code disc unit (20) has a rotating shaft (21) and a code disc (22). The center of a geometric shape of the code disc (22) is coaxial with the rotating shaft (21) and the code disc (22) is fixedly disposed at one end of the rotating shaft (21) to rotate with the rotating shaft (21) as an axis of rotation in the presence of an external force.

Further, the code disc (22) has a disc body (221) that assumes a circular sheet shape and can prevent light from passing. A plurality of first light-transmitting regions (not shown) is disposed on the disc body (221), so as to allow light to pass. Related technical contents such as the position and size of each of the first light-transmitting regions have been disclosed in the related art, and are known to a person of ordinary skill in the art, and thus are not repeated herein.

The light-emitting unit (30) and the light sensing unit (40) are respectively positioned and disposed at opposite positions at two sides of the code disc (22), and the light sensing unit (40) senses light that is emitted from the light-emitting unit (30) and passes through the code disc (22). The specific positioning and disposing techniques are not the technical features of the present invention, and have been disclosed in the related art, and thus are not repeated herein. However, those related to the present invention will be further described as follows.

The light-emitting unit (30) has a light source element (31) that emits sensing light towards the position of the light sensing unit (40). However, the emitted sensing light is blocked by the disc body (221), and can only pass through the code disc (22) to arrive at the light sensing unit (40) through the first light-emitting regions. As such, the sensing light continuously emitted by the light-emitting unit (30) periodically passes through the code disc (22) by the blocking of the disc body (221) and the passage through the first light-transmitting regions, and is sensed by the light sensing unit (40).

The light sensing unit (40) has a light-receiving element (41) and a mask (42). The light-receiving element (41) faces away from the light source element of the light-emitting unit (30) by using the code disc (22) as a boundary, for sensing the sensing light periodically passing through the code disc (22). The mask (42) is located between the light-receiving element (41) and the code disc (22), and is provided with a plurality of second light-transmitting regions (421) allowing the sensing light to pass, such that the shape of a light-receiving area of the light-receiving element (41) is formed by using the second light-transmitting regions (421), so as to enable a sensed analog signal to be closer to a sine-wave value.

Specifically, each of the second light-transmitting regions (421) has two circular areas (4211) (4212) of a same radius, located at positions of a same period that the sensing light passes through the code disc (22) with the centers of circles being symmetrical with each other and spaced from each other, so as to form the shape of the light-receiving area of the light-receiving element (41), thereby receiving the sensing light of the same period and obtaining a corresponding analog signal.

By means of the second light-transmitting regions that are formed on the basis of circular geometric shapes in the first embodiment disclosed above, an analog signal close to a sine-wave value can be obtained, and more importantly, the present invention simplifies the shape of a light-transmitting portion on the mask, so as to enable the light-transmitting portion to be formed on the basis of an easily-manufactured circle, thereby substantially reducing manufacturing difficulty as compared with the related art, and further facilitating the improvement of yield and accuracy.

Further, for the shape of the light-transmitting portion on the mask formed on the basis of a circular shape in the present invention, in addition to the two symmetrical circles of a same radius disclosed in the first embodiment, variations may be made in the size of the radii, the number of circles, or a combination with another geometrical or irregular shape, so as to achieve the similar effect as that in the first embodiment, which are specifically described as follows:

Referring to FIG. 6, FIG. 6 shows that the radii of two circular areas (4211a) (4212a) forming each second light-transmitting region (421a) according to a second embodiment of the present invention are different from each other, which illustrates the variation of the size of the radii of the circles.

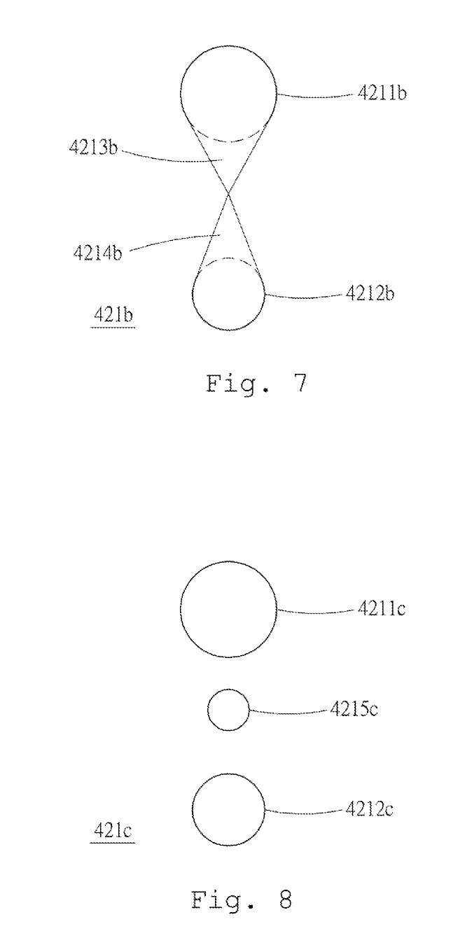

Referring to FIG. 7, FIG. 7 shows the disclosure of a third embodiment of the present invention, where each second light-transmitting region (421b) includes, in addition to two circular regions (4211b) (4212b) with different radii, two triangular regions (4213b) (4214b) connected to each other at the apex, and two sides of each triangular area are respectively tangential to one of the circular areas (4211b) (4212b).

Referring to FIG. 8, FIG. 8 shows the disclosure of a fourth embodiment of the present invention, where each second light-transmitting region (421c) has three circular areas, and the three circular areas (4211c) (4212c) (4215c) are of different radii, are spaced from each other, and correspond to positions of a same period that the sensing light passes through the code disc.

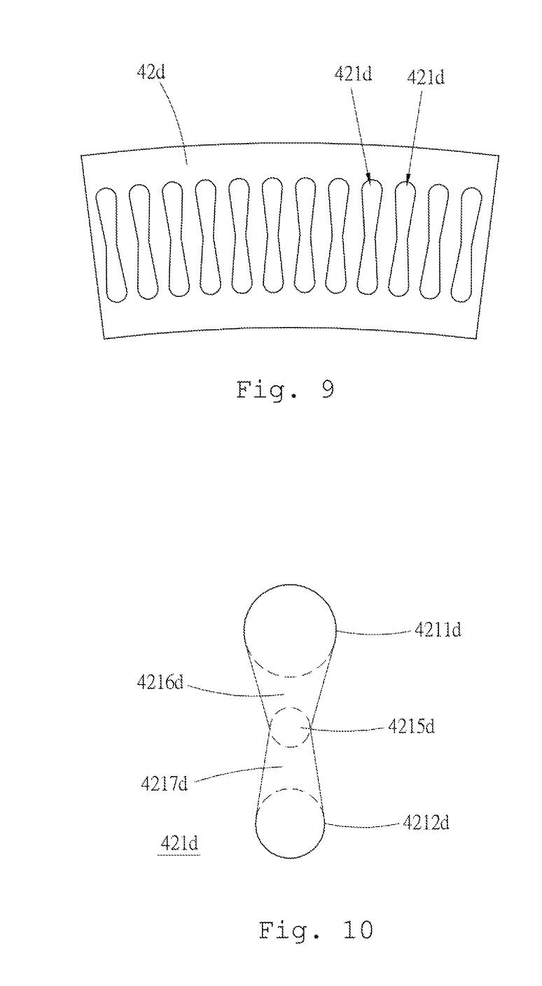

Referring to FIG. 9 and FIG. 10, FIG. 9 and FIG. 10 show the disclosure of a fifth embodiment of the present invention, where each of a plurality of second light-transmitting regions (421d) of a mask (42d) includes, in addition to three circular regions (4211d) (4212d) (4215d) that are of different radii and are spaced from each other, two connection regions (4216d) (4217d) between the adjacent circular regions (4211d) (4212d) (4215d), and the boundaries of the connection regions (4216d) (4217d) are formed by tangents of the adjacent circular regions (4211d) (4212d) (4215d).

The disclosures of the second embodiment to the fifth embodiment are merely intended to illustrate that a circle is used as a basis for forming the shape of a light-transmitting portion of a mask in the present invention, but the present invention is not limited thereto.

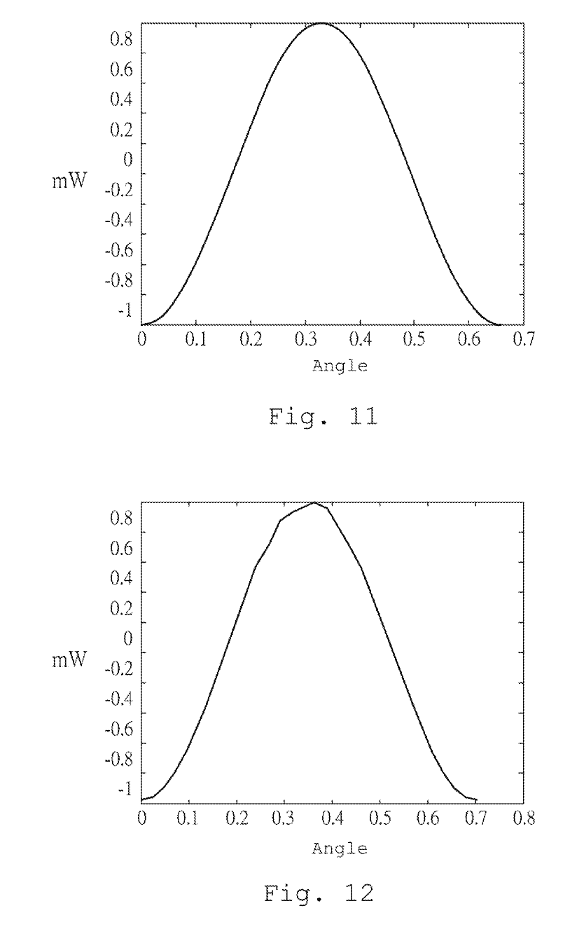

Moreover, with regard to the effects, description is made by using the fifth embodiment as an example. In FIG. 11, a diagram of an analog signal obtained through MATLAB simulation in the fifth embodiment is shown, with a root-mean-square error of 0.0063 compared to an ideal sine-wave, and in FIG. 12, an analog signal obtained through ASAP simulation in the fifth embodiment is shown, with a root-mean-square error of 0.0944 compared to an ideal sine-wave. When compared with the related art that a light-transmitting portion of a mask is formed by a rectangular shape or a V-shape, the results are shown in a table below:

| | MATLAB | ASAP |
|---|---|---|
| Rectangular shape | 0.1507 | 0.7964 |
| V-shape | 0.0380 | 0.1376 |
| The fifth embodiment | 0.0063 | 0.0944 |

It is apparent that the fifth embodiment has an effect of being closer to an ideal sine-wave value, and further has an effect of achieving an easier manufacturing process. The present invention provides more significant improvement in effect as compared with the related art.

What is claimed is:

1. An optical encoder, comprising:
a light-emitting unit, having a light source element for emitting sensing light;
a code disc, located at one side of the light-emitting unit, and having a disc body for preventing the sensing light from traveling and being rotated about a rotating shaft and at least one first light-transmitting region disposed on the disc body for allowing the sensing light to pass, such that when the disc body rotates, the sensing light periodically passes through the code disc through the first light-transmitting region; and
a light sensing unit, located away from the light-emitting unit by using the code disc as a boundary, and having a light-receiving element for sensing the sensing light periodically passing through is the code disc and a mask disposed between the light-receiving element and the code disc wherein the mask has at least one second light-transmitting region allowing the sensing light to pass;
characterized in that:
the second light-transmitting region has two individual circular areas, corresponding to positions the sensing light periodically passes through the code disc,
such that the sensing light periodically passes through the first light-transmitting region by the blocking of the disc body, and then passes through the second light-transmitting region to be sensed by the light-receiving element.

2. The optical encoder according to claim 1, wherein the second light-transmitting region further comprises two triangular areas, disposed between the circular areas and connected to each other at the apex, and two sides of each triangular area are tangential to an adjacent one of the circular areas.

3. The optical encoder according to claim 1, wherein the number of circular areas of the second light-transmitting region is three.

4. The optical encoder according to claim 3, wherein the second light-transmitting region further comprises two connection areas, disposed between the circular areas, and the boundaries of the connection regions are formed by tangents of the adjacent circular areas.

5. The optical encoder according to claim 1, wherein the radii of the circular areas are different from each other.

6. The optical encoder according to claim 3, wherein the radii of the circular areas are different from each other.

7. The optical encoder according to claim 4, wherein the radii of the circular areas are different from each other.
